(19) United States
(12) Patent Application Publication
(10) Pub. No.: US 2016/0330678 A1
(43) Pub. Date: Nov. 10, 2016

(54) METHOD AND DEVICE FOR TRANSMITTING AND RECEIVING DISCOVERY REFERENCE SIGNAL THROUGH CHANNEL OF UNLICENSED FREQUENCY BAND

(71) Applicant: Electronics and Telecommunications Research Institute, Daejeon (KR)

(72) Inventors: Chanho YOON, Daejeon (KR); Young Jo KO, Daejeon (KR); Eunkyung KIM, Daejeon (KR); Seung-Kwon BAEK, Daejeon (KR)

(21) Appl. No.: 15/148,108

(22) Filed: May 6, 2016

(30) Foreign Application Priority Data
May 7, 2015 (KR) 10-2015-0063803
Sep. 1, 2015 (KR) 10-2015-0123725
Sep. 10, 2015 (KR) 10-2015-0128193
Mar. 22, 2016 (KR) 10-2016-0034294

(51) Int. Cl. H04W 48/16; H04W 74/00; H04W 72/04; H04W 8/00; H04W 16/14

(52) U.S. Cl. CPC H04W 48/16; H04W 8/005; H04W 16/14; H04W 72/042; H04W 74/006

(57) ABSTRACT

Disclosed is a method for a base station to transmit a discovery reference signal (DRS) through a channel of an unlicensed band. The base station attempts a first access to the channel of the unlicensed band so as to transmit a first DRS in a first DRS measurement timing configuration (DMTC) period. When the first access fails, the base station attempts a second access to the channel of the unlicensed band with a shorter predetermined period than the first DMTC period so as to transmit a second DRS in the first DMTC period.

### CROSS-REFERENCE TO RELATED APPLICATION

This application claims priority to and the benefit of Korean Patent Application Nos. 10-2015-0063803, 10-2015-0123725, 10-2015-0128193, and 10-2016-0034294 filed in the Korean Intellectual Property Office on May 7, 2015, Sep. 1, 2015, Sep. 10, 2015, and Mar. 22, 2016, the entire contents of which are incorporated herein by reference.

### BACKGROUND OF THE INVENTION

(a) Field of the Invention

The present invention relates to a method and device for transmitting/receiving a discovery reference signal in an unlicensed frequency bandwidth-based wireless communication cellular system.

(b) Description of the Related Art

Conventional long term evolution (LTE) cellular networks have been operated for licensed bands. As demands for high-capacity and high-speed data services have been increased although technical developments for increasing the capacity have been continuously performed, the LTE standard has adopted a way to accept the unlicensed band and increase the capacity without a limit to the existing licensed bands. At the present time, standardization thereof is in active progress.

However, regarding the unlicensed band, differing from the licensed bands that are not hindered by other service providers or devices but have a high level of freedom, the problem of coexistence with devices operating in other unlicensed bands has to be solved. That is, a channel accessing and occupying method in a form of limited use when chances are provided without dramatically lowering performance of other devices on the same unlicensed channel is needed.

To solve the problem of coexistence, a method for transmitting a carrier after sensing the same (e.g., a clear channel assessment (CCA) method or a listen before talk (LBT) method) is widely used. The channel accessing method is initially performed by monitoring a channel. That is, the device senses activity of an unlicensed channel shared with another device, holds transmission of a radio signal when energy of a channel is measured, and uses the corresponding channel (transmitting or outputting the radio signal) when no energy is sensed from the channel. When the device senses an idle state of the channel and transmits a signal, other devices determine that the energy is sensed on the corresponding channel and the corresponding channel is busy, and they hold transmission of signal. That is, the method for accessing a channel of an unlicensed band may be one of time-division multiple access methods for dividing time and allowing a plurality of devices to access a radio channel. A cellular system for an unlicensed band is mainly operated by a small cell. Therefore, a discovery reference signal (DRS) applicable to the small cell may be identically applied or used to the unlicensed band in a like manner.

The existing LTE base station of a small cell based on the licensed band (hereinafter, a small base station) is turned off when an access terminal is not provided so as to minimize interference applied to a neighboring base station. However, when the small base station is totally turned off, a terminal accessing coverage may not determine whether a corresponding base station is provided or not, so the small base station when in an “off state” periodically transmits a discovery reference signal (DRS) and broadcasts whether the small base station is in an off state exists. The discovery reference signal includes a reference signal such as a primary synchronization signal (PSS), a secondary synchronization signal (SSS), or a cell-specific reference signal (CRS), and is transmitted periodically (e.g., at a period of 40 ms, 80 ms, 160 ms, or 320 ms). The terminal uses the discovery reference signal in order to analyze a cell ID, base station signal intensity, and channel quality information. The terminal may further receive a DRS of an adjacent cell and report radio resource management (RRM) information to the base station.

Therefore, the terminal accessing the coverage of a small base station in the off state receives a DRS, and sends a report for providing RRM of the small base station to a macrocell base station (hereinafter, a macro base station) that is always in the on state. The macro base station switches the small base station in the off state to the on state, and the corresponding small base station may provide a service to the terminal in the small base station coverage area. When the small base station is in the on state, it continuously transmits a CRS. The terminal may consecutively acquire and estimate time synchronization and frequency synchronization on the received signal and may perform tracking through the continuous CRS.

As described, the DRS is a means for efficiently using power in the existing licensed band of the small base station and an excellent means for the terminal to report RRM, and it is also used to minimize interference of an adjacent small (or macro) cell. The DRS may be used to switch the small base station using an unlicensed band in the off state to the on state in a like manner of the licensed band. However, when the macro cell turns on the small base station operated in the unlicensed band, it may not continuously transmit the CRS after turning on the small cell in a like manner of the licensed band because of a use duration regulation (e.g., a temporal continuous transmission that is greater than 4 ms is not allowed in Japan) on the unlicensed band channel according to a characteristic of the time-division access form of the unlicensed band. Hence, the method for the terminal to receive the continuous CRS and maintain time and frequency synchronization, that is like the operation applied to the licensed band, is inapplicable to the unlicensed band

As a result, the terminal has to use a case in which a DRS occasion (transmission of a discovery reference signal) is randomly generated to receive time-frequency synchronization with the small base station for maintenance. That is, only when the DRS occasion is randomly generated in the unlicensed band, a basic operation of the terminal relating to receiving the DRS also used to receive time synchronization and frequency synchronization provided by the CRS included in the DRS is assumed for the terminal. However, when the basic operation is assumed, it may be difficult to maintain synchronization with the base station when failing to receive the DRS by more than a predetermined number of times.

It is also difficult to control the time-frequency synchronization by receiving an initial single DRS. The PSS and SSS of the existing DRS have a characteristic of a narrowband, so it is difficult for the terminal to accurately acquire precise orthogonal frequency division multiplexing (OFDM) symbol timing of the signal in the unlicensed band using a relatively wide band by receiving a single DRS. Therefore, when acquiring initial synchronization only with the PSS and the SSS (when the terminal receives the DRS of a small base station for the first time), the terminal may adequately acquire relatively precise OFDM symbol timing only after receiving multiple number DRSs of the corresponding serving cell.

In addition, the DRS of the unlicensed band may be used to both maintain the time-frequency synchronization of the terminal and report RRM to the base station. However, when failing to receive the DRS, the terminal may not report the RRM to a Primary Cell (PCell). As described above, the DRS is an important signal to be received for a terminal operating in the unlicensed band, but its receiving rate in the unlicensed band is low in a statistical manner. Particularly, there is a reason why the receiving rate of the DRS is lower than the receiving rate of general payload data carrying signals. The DRS must be transmitted at a predetermined period by the rules. Therefore, a transmission section is limited by the predetermined period, and when the channel is busy in the transmission section, an opportunity for transmission goes to the next period. This is because it is not guaranteed to periodically transmit the DRS according to the regulation (including a content of CCA) such as the LBT in the unlicensed band. That is, this is because a radio channel may be occupied in the DRS occasion section by another device (e.g., a Wi-Fi system, a radar, etc.). Further, particularly, an LTE frame in the unlicensed band has a rule to be time-synchronized with an LTE frame transmitted in the licensed band, which is because the rule is based on a “Carrier Aggregation” concept of the LTE standard. Therefore, the unlicensed band has a condition in which the channel is occupied in the time division manner and a transmission condition in which the unlicensed band must be frame-synchronized with the licensed band. In short, due to an additional requirement relating to the frame alignment conformance to the licensed band, a probability that the DRS can be periodically transmitted in the unlicensed band may be decreased further.

Another additional problem relates to a DRS false alarm. When the base station has succeeded in transmitting the DRS through the LBT in the unlicensed band, a basic operation by the terminal in the unlicensed band is to check validity that is whether the received signal is a DRS. That is, the terminal must perform a determination by decoding the PSS, the SSS, and the CRS in order to identify whether the signal received for the DRS period is a DRS or an invalid signal (e.g., a Wi-Fi signal, etc.). Further, the determination process includes determining whether the DRS additionally received by the terminal is a DRS of a neighboring base station. As a result, the terminal must periodically detect the DRS in the unlicensed band and must receive it for more than a predetermined frequency, which functions as a restriction, so something such as a false alarm may occur. There is no physical determination method for checking errors such as the cyclic redundancy check (CRC), so the probability of false alarm in which the terminal determines the DRS signal of another base station and the Wi-Fi signal to be a DRS signal of a valid serving cell exists at all times.

Therefore, a method for solving the above-described problems is needed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and device for transmitting a DRS in an unlicensed frequency bandwidth.

An exemplary embodiment of the present invention provides a method for a base station to transmit a discovery reference signal (DRS) through a channel of an unlicensed band. The method includes: attempting a first access to the channel of the unlicensed band so as to transmit a first DRS in a first DRS measurement timing configuration (DMTC) period; and when the first access fails, attempting a second access to the channel of the unlicensed band with a predetermined period that is shorter than the first DMTC period so as to transmit a second DRS in the first DMTC period.

The predetermined period may represent a period for transmitting a synchronization signal in a licensed band.

The attempting of a second access may include attempting the second access with the predetermined period until a transmission of the second DRS is successful in the first DMTC period.

The synchronization signal may include at least one of a primary synchronization signal (PSS) and a secondary synchronization signal (SSS). The predetermined period may be 5 ms.

The method may further include, when the second access is successful, multiplexing the second DRS and a physical downlink shared channel (PDSCH) and transmitting the same.

The method may further include, when the second access is successful, transmitting a synchronization signal included in the second DRS from a same resource element as a resource element for transmitting the synchronization signal in the licensed band.

The attempting of a second access may include sensing the unlicensed band channel, and when the channel of the unlicensed band is sensed to idle, transmitting a reservation signal with a variable length so as to reserve the channel of the unlicensed band.

The method may further include, when the second access is successful, transmitting a first fine symbol time field (FSTF) signal for notifying a terminal of a transmission of the second DRS from a time when a transmission of the reservation signal is finished to a time for transmitting the second DRS.

The second DRS may include a primary synchronization signal (PSS), a secondary synchronization signal (SSS), and a cell-specific reference signal (CRS).

Times for starting and ending a transmission of the second DRS may correspond to a boundary of a subframe for a licensed band.

The predetermined period may correspond to a length of a subframe for a licensed band.

The attempting of a second access may include attempting the second access with the predetermined period until a transmission of the second DRS is successful in a DMTC window configured in the first DMTC period.

Another embodiment of the present invention provides a method for a base station to transmit a discovery reference signal (DRS) through a channel of an unlicensed band. The method includes: generating a first DRS with a predetermined time length; and mapping a first signal on a remaining time domain symbol except a time domain symbol on which a signal is mapped from among time domain symbols belonging to the first DRS.

The first signal may include at least one of a physical downlink control channel (PDCCH) and a physical downlink shared channel (PDSCH).

The mapping of a first signal may include mapping the first signal transmitted through a channel of a licensed band in a same time domain symbol as the remaining time domain symbol of the first DRS on the remaining time domain symbol of the first DRS.

The generating of a first DRS may include generating a cell-specific reference signal (CRS).

The mapping of a first signal may include mapping the CRS included in the first DRS on at least one of remaining time domain symbols of the first DRS by using the CRS included in the first DRS as the first signal.

The mapping of a first signal may include generating a cell-specific broadcast signal (CBS) using an antenna port, as the first signal.

Yet another embodiment of the present invention provides a method for a terminal to receive a discovery reference signal (DRS) through a channel of an unlicensed band. The method includes: determining whether a first fine symbol time field (FSTF) signal for a first DRS is detected in a DRS measurement timing configuration (DMTC) period; and when the detection of the first FSTF signal fails, attempting to detect a second FSTF signal for a second DRS with a predetermined period.

The method may further include, when the detection of the second FSTF signal is successful, receiving the second DRS together with a physical downlink shared channel (PDSCH).

The predetermined period may represent a period for transmitting a synchronization signal in a licensed band.

### BRIEF DESCRIPTION OF THE DRAWINGS

FIG. 1 shows a predictable DRS transmission result that may occur in an unlicensed band.

FIG. 2 shows a time when an eDRS is transmitted in an unlicensed band according to an exemplary embodiment of the present invention.

FIG. 3 shows detailed timing of a time when a DRS is transmitted in an unlicensed band and a time when a preamble is transmitted after an LBT according to an exemplary embodiment of the present invention.

FIG. 4 shows detailed timing of a time when an eDRS is transmitted in an unlicensed band and a time when a preamble is transmitted after an LBT according to an exemplary embodiment of the present invention.

FIG. 5 shows a case in which a PDSCH and a DRS are multiplexed and are transmitted according to an exemplary embodiment of the present invention.

FIG. 6 shows detailed timing of a time when an eDRS is transmitted in an unlicensed band and a time when a preamble is transmitted after an LBT according to another exemplary embodiment of the present invention.

FIG. 7 shows a configuration of a preamble with a variable length applied to a DRS or an eDRS of an unlicensed band according to an exemplary embodiment of the present invention.

FIG. 8 shows a short preamble according to another exemplary embodiment of the present invention.

FIG. 9 shows a long preamble according to the other exemplary embodiment of the present invention.

FIG. 10 shows a default DRS according to an exemplary embodiment of the present invention.

FIG. 11 shows a method for filling a physical downlink control channel (PDCCH) and a PDSCH signal of a licensed band into part of a DRS according to an exemplary embodiment of the present invention.

FIG. 12 shows a method for filling an existing reference signal into a void section of a DRS according to an exemplary embodiment of the present invention.

FIG. 13 shows a method for filling a cell-specific broadcast signal (CBS) into a void section of a DRS according to an exemplary embodiment of the present invention.

FIG. 14 shows a method for mapping a CBS on a frequency axis and a modulation method for respective symbols according to an exemplary embodiment of the present invention.

FIG. 15 shows a base station according to an exemplary embodiment of the present invention.

FIG. 16 shows a terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a terminal may indicate a mobile terminal, a mobile station, an advanced mobile station, a high reliability mobile station, a subscriber station, a portable subscriber station, an access terminal, or user equipment, and it may include entire or partial functions of the terminal, the mobile terminal, the mobile station, the advanced mobile station, the high reliability mobile station, the subscriber station, the portable subscriber station, the access terminal, or the user equipment.

In addition, a base station (BS) may indicate an advanced base station, a high reliability base station, a node B, an evolved node B (eNodeB), an access point, a radio access station, a base transceiver station, a mobile multihop relay (MMR)-BS, a relay station functioning as a base station, a high reliability relay station functioning as a base station, a repeater, a macro base station, or a small base station, and it may include entire or partial functions of the base station, the advanced base station, the HR-BS, the nodeB, the eNodeB, the access point, the radio access station, the base transceiver station, the MMR-BS, the relay station, the high reliability relay station, the repeater, the macro base station, or the small base station.

In the present specification, ‘A or B’ may include ‘A’, ‘B’, or ‘both A and B’.

An existing small-cell LTE base station (hereinafter a small base station) based on a licensed band is turned off when there is no access terminal in order to minimize interference applied to a neighboring base station. However, when the small base station is turned off, the terminal accessing coverage may not determine whether there is a corresponding base station, so the small base station, when in an off state, periodically transmits a discovery reference signal (DRS), and broadcasts an existence state of a small base station that is in the off state. The DRS includes reference signals such as a primary synchronization signal (PSS), a secondary synchronization signal (SSS), or a cell-specific reference signal (CRS), and is periodically (e.g., a period of 40, 80, 160, or 320 ms) transmitted. The terminal may use the DRS so as to analyze an ID of a cell to which the terminal belongs, intensity of a base station signal, and channel quality information. Further, the terminal may receive a DRS of an adjacent cell, and may report radio resource management (RRM) information to the base station.

Therefore, the terminal accessing the coverage of the small base station in the off state receives a DRS and sends a report for providing RRM of the small base station to a macro cell base station (hereinafter a macro base station) that is in the on state. The macro base station switches the small base station in the off state to the on state, and the corresponding small base station may provide a service to the terminal in the coverage area. When the small base station is in the on state, it continuously transmits the CRS. The terminal may consecutively acquire, estimate, and track time synchronization and frequency synchronization on the received signal through continuous CRSs.

As described, the DRS becomes a means for efficiently using power and reporting RRM by the terminal in the licensed band of the existing small base station, and is also used to minimize interference of an adjacent small (or macro) cell. The DRS may be used to switch the small base station using an unlicensed band in the off state to the on state in a like manner of the licensed band. However, when the macro cell turns on the small base station operated in the unlicensed band, it may not continuously transmit the CRS after turning on the small cell in a like manner of the licensed band because of a use duration regulation (e.g., temporal continuous transmission that is greater than 4 ms is not allowed in Japan) on the unlicensed band channel according to a characteristic of the time-division access form of the unlicensed band. Hence, the method for the terminal to receive the continuous CRS and maintain time and frequency synchronization, that is like the operation applied to the licensed band, is inapplicable to the unlicensed band. As a result, the terminal has to use a case in which a DRS occasion (transmission of a discovery reference signal) is randomly generated to receive time-frequency synchronization with the small base station for maintenance. That is, only when the DRS occasion is randomly generated in the unlicensed band, a basic operation of the terminal relating to receiving the DRS also used to receive time synchronization and frequency synchronization provided by the CRS included in the DRS is assumed for the terminal. However, when the basic operation is assumed, it may be difficult to maintain synchronization with the base station when failing to receive the DRS by more than a predetermined number of times.

It is also difficult to control the time-frequency synchronization by receiving an initial single DRS. The PSS and SSS of the existing DRS have a characteristic of a narrowband, so it is difficult for the terminal to accurately acquire precise orthogonal frequency division multiplexing (OFDM) symbol timing of the signal in the unlicensed band using a relatively wide band by receiving a single DRS. Therefore, when acquiring initial synchronization only with the PSS and the SSS (when the terminal receives the DRS of a small base station for the first time), the terminal may adequately acquire relatively precise OFDM symbol timing only after receiving the DRS corresponding to the serving cell for a multiple number of times.

A method according to an exemplary embodiment of the present invention may belong to a physical layer of the LTE wireless mobile communication system. In detail, when the LTE system is operated in the unlicensed band, the radio resource management (RRM) may be operated based on a content reported to the base station by the terminal. The DRS may be an efficient reference signal for the RRM. The method according to an exemplary embodiment of the present invention relates to a method for transmitting the DRS. The DRS is periodically transmitted by the base station, and the DRS transmission may be held or canceled according to a characteristic of the unlicensed band.

A method for operating an LTE system in an unlicensed band with a characteristic of non-continuous signal transmission because of regulations and a condition and process (which may be useful for the small cell) for transmitting a DRS in an unlicensed band will now be described.

Also, a process for a case in which a channel is busy for a predetermined DRS measurement timing configuration (DMTC) period will now be described.

Further, a method for generating a DRS synchronization reference signal that is a reference for the time synchronization and the frequency synchronization so as to control or maintain the synchronization on a data received signal of the terminal will now be described.

In addition, a resolution that is appropriate for the signal in the unlicensed band using a wideband is needed. A method for providing accurate fast Fourier transform (FFT) timing of an OFDM symbol by using a DRS synchronization reference signal defined to part of the DRS burst will now be described. Further, a method for generating a DRS synchronization reference signal for frame synchronization between an unlicensed band and a licensed band for the purpose of a further accurate RRM report will now be described.

Further, a configuration in which a DRS is modified to have a continuous characteristic of a signal to satisfy the unlicensed band will now be described.

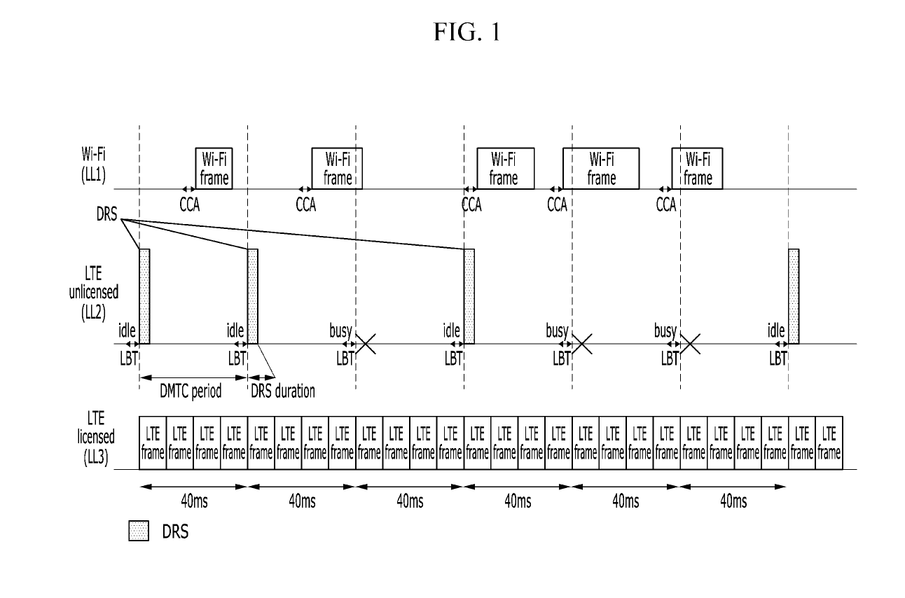

FIG. 1 shows a predictable DRS transmission result that may occur in an unlicensed band.

In detail, FIG. 1 exemplifies a case in which an LTE base station (LL2) operable in the unlicensed band shares an identical unlicensed band (e.g., a 5 GHz frequency bandwidth) with an IEEE 802.11a/n/ac wireless local area network (WLAN) device. The LTE base station (LL2) may be an LTE license assisted access (LAA) device. The LTE base station (LL2) may be operable in the unlicensed band and the licensed band, and in this case, it may simultaneously transmit a signal of the unlicensed band and a signal of the licensed band.

In further detail, FIG. 1 exemplifies a predictable situation that may occur when the LTE base station (LL2) transmits a DRS in a designated DRS transmission section while coexisting with a Wi-Fi device (LL1) and an LTE base station (LL3) in a licensed band and maintaining synchronization with the licensed band. The LTE base station (LL3) is operated in the licensed band.

A clear channel assessment (CCA) exemplified in FIG. 1 represents a method for the Wi-Fi device (LL1) to determine whether a radio channel is in use by another device according to an energy level. The Wi-Fi device (LL1) transmits a signal of a Wi-Fi frame through the corresponding channel when the CCA on the radio channel is successful. Here, the success of CCA on the channel signifies that the device having performed a CCA occupies the corresponding channel.

In a like manner, a listen-before-talk (LBT) exemplified in FIG. 1 represents a method for performing a same function as the CCA. A busy state indicates a state in which a channel is occupied, and an idle state shows that no device uses the corresponding channel. A DMTC period represents a period for transmitting a DRS, and FIG. 1 exemplifies the case in which the DMTC period is 40 ms (=a length of four LTE frames). FIG. 1 exemplifies a case in which a start and an end of the DMTC period correspond to a boundary of the LTE frame. A DRS duration or a DRS occasion represents a time when the DRS is continuously transmitted.

FIG. 1 exemplifies the case in which the LTE base station (LL2) is periodically transmitting the DRS and it fails to transmit the third DRS. Before transmitting the third DRS, the LTE base station (LL2) determines that the channel in the unlicensed band is busy (the Wi-Fi device (LL1) occupies the corresponding unlicensed band channel at the corresponding time), and cancels transmission of the DRS. In a like manner, the LTE base station (LL2) fails to transmit the fifth DRS and the sixth DRS (the Wi-Fi device (LL1) occupies the corresponding unlicensed band channel at the corresponding time), and the failure of transmission of DRSs exemplified in FIG. 1 may actually occur in the unlicensed band.

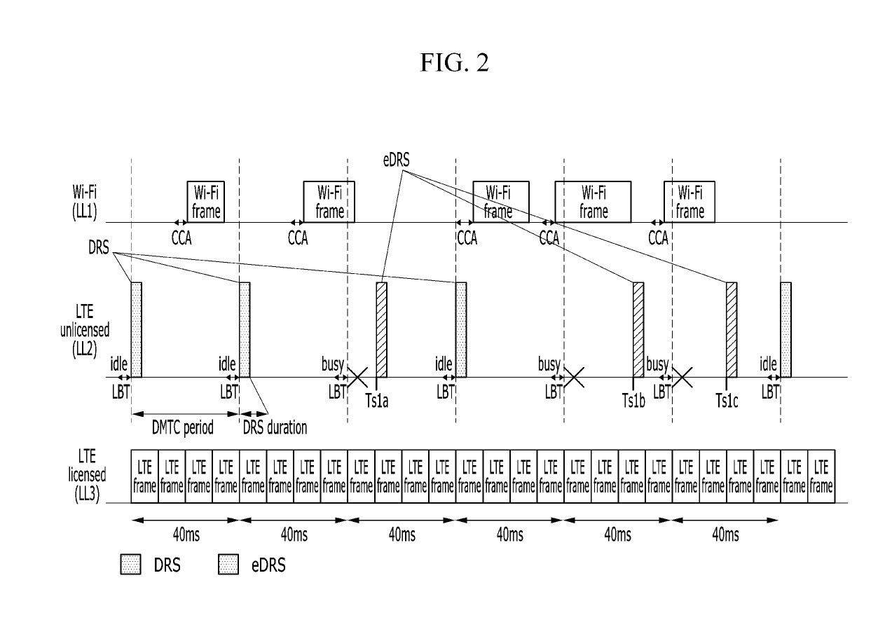

Many devices irregularly share the channel in the unlicensed band so the periodicity of the DRS is not guaranteed. Therefore, a technique for complementing the transmission of DRS in preparation for such an environment is needed. As one method for this, a subsidiary function for transmitting an extended DRS will now be described with reference to FIG. 2.

FIG. 2 shows a time when an eDRS is transmitted in an unlicensed band according to an exemplary embodiment of the present invention. In detail, FIG. 2 exemplifies a method for attempting to retransmit a DRS for each predetermined period (e.g., 5 ms). Here, the predetermined period may be a period in which the synchronization signals (PSS and SSS) are transmitted in the licensed band, and for example, it may be 5 ms.

The default DRS of the unlicensed band is transmitted when the PSS and the SSS of the licensed band are transmitted and when the LBT is successful with the same timing as the timing configured to the DMTC. Here, the success of the LBT on the channel signifies that the device having performed an LBT occupies the corresponding channel.

The extended DRS (hereinafter an eDRS) is transmitted to recover the transmission of DRS that has failed in the DMTC period when the LBT is performed for each 5 ms (i.e., when the PSS or the SSS is transmitted in the licensed band) and the LBT has succeeded. For example, when the LTE base station (LL2) fails in periodical transmission of DRS (e.g., third, fifth, and sixth transmission of DRS), it may perform the LBT for each 5 ms after the failure of transmission of DRS, and it may transmit an eDRS when the LBT is successful (Ts1a, Ts1b, and Ts1c).

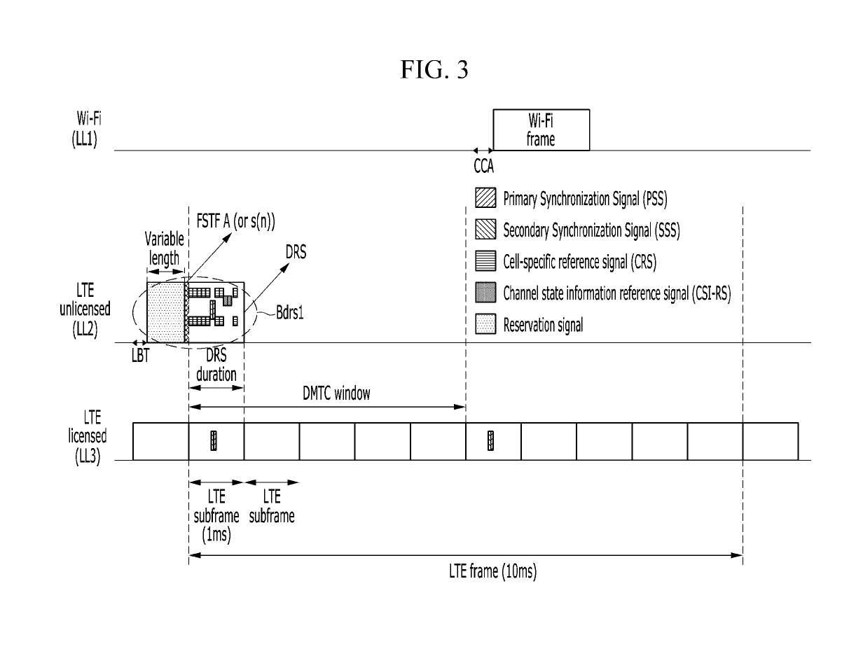

Detailed timing in connection with the transmission time of the PSS and the SSS in the licensed band and the LBT operation will now be described with reference to FIG. 3.

FIG. 3 shows detailed timing of a time when a DRS is transmitted in an unlicensed band and a time when a preamble is transmitted after an LBT according to an exemplary embodiment of the present invention.

As exemplified in FIG. 3, the DRS may include a PSS, a SSS, a CRS, and a channel state information-reference signal (CSI-RS). In order for the time when the synchronization signals (PSS and SSS) included in the DRS to correspond to the time when the synchronization signals (PSS and SSS) are transmitted in the licensed band (e.g., in order for the transmission time of the synchronization signals (PSS and SSS) transmitted by the LTE base station (LL2) to correspond to the transmission time of the synchronization signals (PSS and SSS) transmitted by the LTE base station (LL3)), a DMTC window may be set to be 5 ms. That is, when the LTE frame is 10 ms, the DMTC window may be 5 ms. Further, a length of the DMTC may be 0.85729166 ms that is equivalent to a length of at least twelve OFDM symbols. FIG. 3 exemplifies the case in which a LTE frame includes ten LTE subframes, a DRS duration is equal to a length of one LTE subframe (e.g., 1 ms), and the LTE base station (LL3) transmits the synchronization signals (PSS and SSS) with the period of 5 ms.

When the transmission of DRS is successful at the configured DRS transmission time, a DRS burst (Bdrs1) may include a reservation signal with a variable length, a fine symbol time field (FSTF) type-A signal (or a preamble signal (s(n))) for notifying of an OFDM symbol synchronization reference, and a DRS. In detail, when the LBT on the channel of the unlicensed band is successful, the LTE base station (LL2) may transmit a reservation signal for reserving the corresponding channel, may transmit an FSTF type-A signal for time synchronization through the corresponding channel (or may continuously transmit the reservation signal instead of a time synchronization signal without transmitting the time synchronization signal), and may transmit the DRS through the corresponding channel at the configured DRS transmission time.

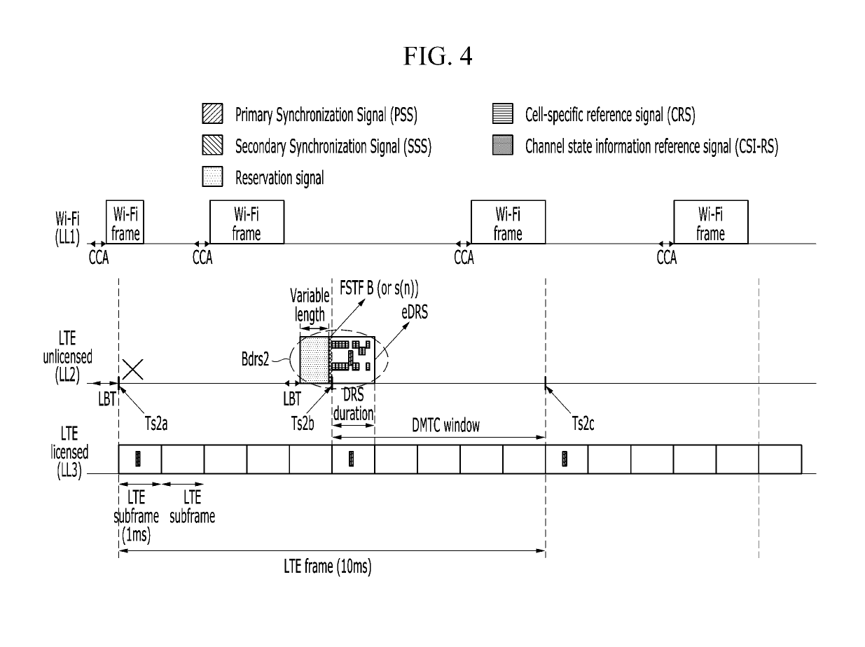

FIG. 4 shows detailed timing of a time when an eDRS is transmitted in an unlicensed band and a time when a preamble is transmitted after an LBT according to an exemplary embodiment of the present invention.

In detail, in FIG. 4, when the LTE base station (LL2) fails to transmit the DRS during the configured DMTC period, it may attempt to transmit an eDRS when the time of 5 ms passes (Ts2b) from the time (Ts2a) when the transmission of DRS has failed. In detail, the LTE base station (LL2) may perform an LBT before the time passes over 5 ms from the time (Ts2a) when the transmission of DRS fails.

The eDRS burst (Bdrs2) may be configured to be similar to the DRS burst (Bsrs1). However, the eDRS burst (Bdrs2) includes a FSTF type-B instead of the FSTF type-A.

When the LTE base station (LL2) fails to transmit the eDRS at the time (Ts2b), it reattempts to transmit the eDRS at a time (Ts2c) that passes the time (Ts2b) by 5 ms. When the LTE base station (LL2) fails to transmit the eDRS at the time (Ts2c), it reattempts to transmit the eDRS at a time (Ts2c) that passes the time (Ts2c) by 5 ms. That is, when the LTE base station (LL2) fails to transmit the DRS at the DRS transmission time (Ts2a) configured within the DMTC period, it may consecutively attempt to transmit the eDRS for a predetermined period (e.g., 5 ms) before reaching the next DMTC period. For example, when the DMTC period is configured to be 40 ms, the LTE base station (LL2) may attempt transmission of the eDRS seven additional times.

In addition, when the LTE base station (LL2) succeeds in transmitting the DRS or the eDRS, it may additionally retransmit the same a predetermined number of times (e.g., N number of times) if needed.

The DRS or the eDRS may be simultaneously transmitted with a physical downlink shared channel (PDSCH), that is, downlink data.

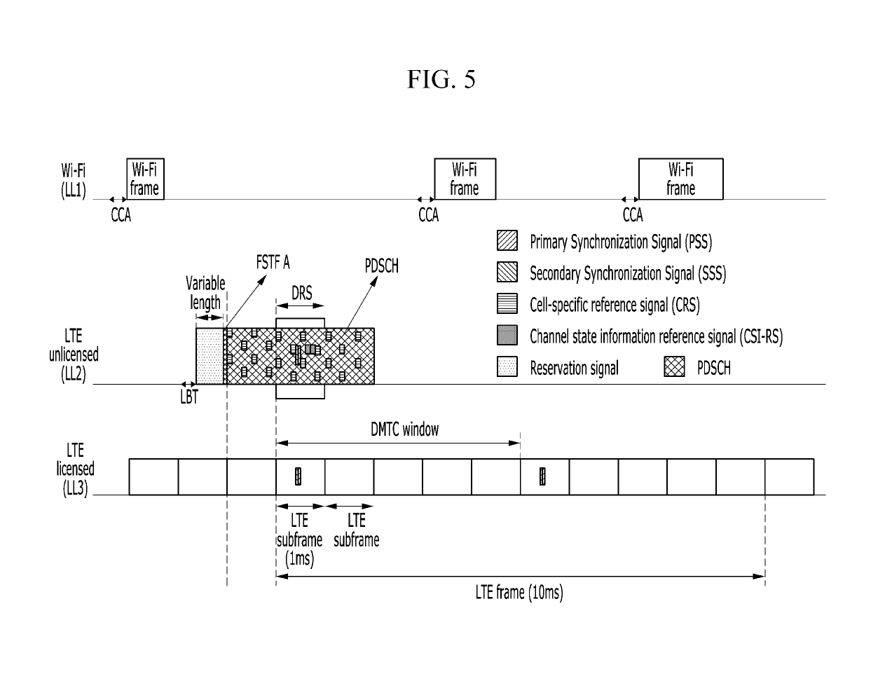

FIG. 5 shows a case in which a PDSCH and a DRS are multiplexed and are transmitted according to an exemplary embodiment of the present invention.

A method for attempting retransmission of DRS (or eDRS) for each predetermined period (e.g., 5 ms) has a merit that it is possible to multiplex the DRS (or eDRS) and a downlink data signal and transmit the same as exemplified in FIG. 5. For example, as exemplified in FIG. 5, when the LBT on the channel of the unlicensed band is successful, the LTE base station (LL2) may transmit a reservation signal through the corresponding channel so as to reserve the corresponding channel, may transmit the FSTF type-A signal for the time synchronization through the corresponding channel, may multiplex the PDSCH and the DRS, and may transmit the same through the corresponding channel. Here, the FSTF type-A may be omitted and be substituted with the reservation signal.

As exemplified in FIG. 5, the synchronization signals (PSS and SSS) transmitted for each predetermined period (e.g., 5 ms) in the licensed band are maintained to be transmitted at the same time and the same resource element as the licensed band in the unlicensed band so no ambiguity is generated when the terminal demodulates the PDSCH.

The terminal may accurately know at which physical resource block (PRB) and OFDM symbol position it has to skip the synchronization signals (PSS and SSS) and the resource element of the CSI-RS in any case (e.g., when a start time and an end time of a downlink burst of the unlicensed band are variable). Accordingly, the problem of ambiguity (i.e., a rate-matching at a receiving end) on signal mapping that is performed with respect to time and frequency on the components (positions of the PSS, SSS, and CSI-RS) included in the DRS (or eDRS) and the PDSCH from among the components of the signal received by the terminal is not generated.

The basic configuration of the DRS (or eDRS) includes the PSS, SSS, and CRS (the CSI-RS is an optional component) so the DRS (or eDRS) does not collide with the PDSCH regarding the resource element. That is, the resource mapping in the unlicensed band corresponds to the existing resource mapping in the licensed band, so the signal generated by multiplexing the DRS (or eDRS) and the PDSCH does not have a new signal configuration. Resultantly, the signal generated by multiplexing the DRS (or eDRS) and the PDSCH has the same signal configuration as the signal of the licensed band.

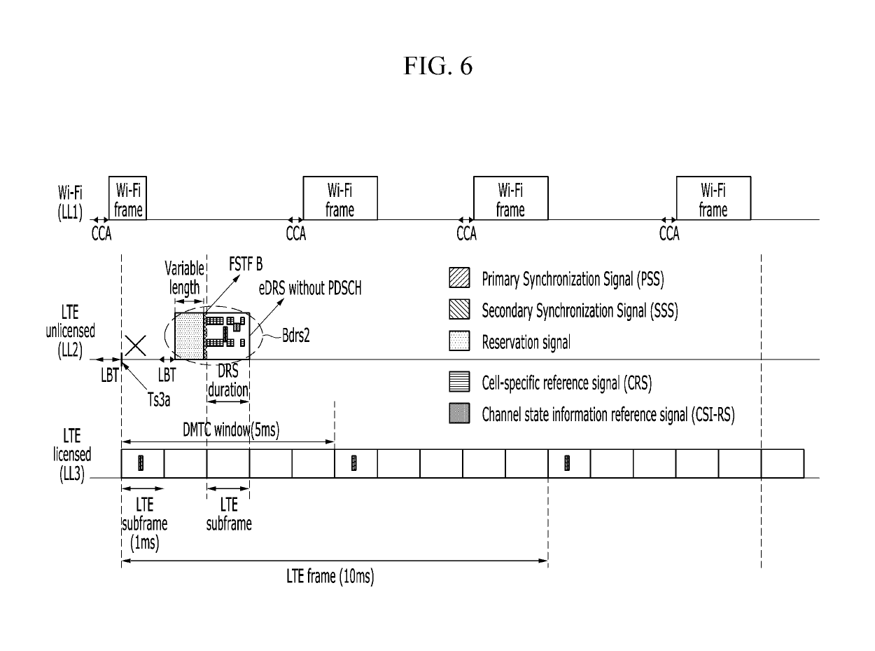

FIG. 6 shows detailed timing of a time when an eDRS is transmitted in an unlicensed band and a time when a preamble is transmitted after an LBT according to another exemplary embodiment of the present invention.

In detail, FIG. 6 exemplifies a method for attempting a transmission of eDRS for each predetermined period (e.g., 1 ms) in the configured DMTC window section. Here, the predetermined period for a retransmission of eDRS may correspond to a length (e.g., 1 ms) of the subframe for the licensed band.

The above-noted method may attempt to transmit the eDRS burst (Bdrs2) the number of times found by dividing the length of the DMTC window by 1 ms minus one time. For example, as exemplified in FIG. 6, when the DMTC window is configured to be 5 ms and the LTE base station (LL2) fails in the transmission of DRS at the DRS transmission time (Ts3a), it may attempt the retransmission of eDRS four times in the DMTC window. The LTE base station (LL2) may not attempt the transmission of eDRS other than the DMTC window section.

According to the method exemplified in FIG. 6, an ambiguity of the rate matching may occur because of a misalignment between the positions of the synchronization signals (PSS and SSS) of the licensed band and the positions of the synchronization signals (PSS and SSS) included in the eDRS. Because of this, the case of transmitting the eDRS together with the PDSCH is excluded in the method exemplified in FIG. 6. That is, as exemplified in FIG. 6, the LTE base station (LL2) transmits the eDRS without multiplexing the same with the PDSCH.

The DRS (or eDRS) burst of the unlicensed band according to an exemplary embodiment of the present invention may have next four characteristics.
A preamble (reservation signal) for a channel reservation
An FSTF signal (e.g., FSTF type-A signal or FSTF type-B signal) for fine OFDM symbol timing
A DRS waveform in a continuous burst form
A method for configuring a length of a DRS

From among the components of the DRS (or eDRS) burst, the preamble (reservation signal) that is a component excluding the DRS (or eDRS) and the FSTF signal may not be transmitted so as to increase a DRS signal transmission probability, depending on the case. The FSTF signal may also be substituted with the preamble (reservation signal) depending on the case.

The four characteristics will now be described in detail.

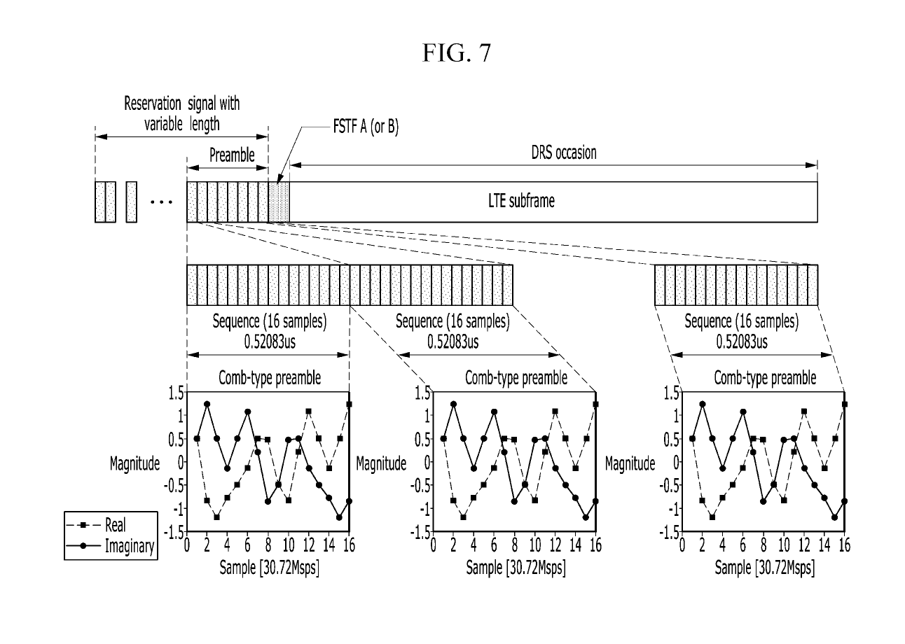

The preamble (reservation signal) for a channel reservation will now be described in detail with reference to FIG. 7 to FIG. 9.

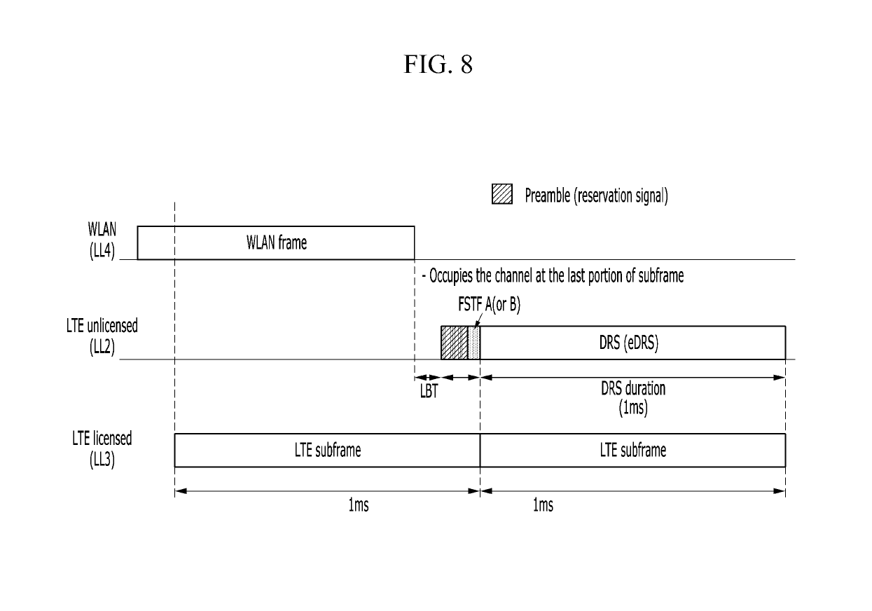

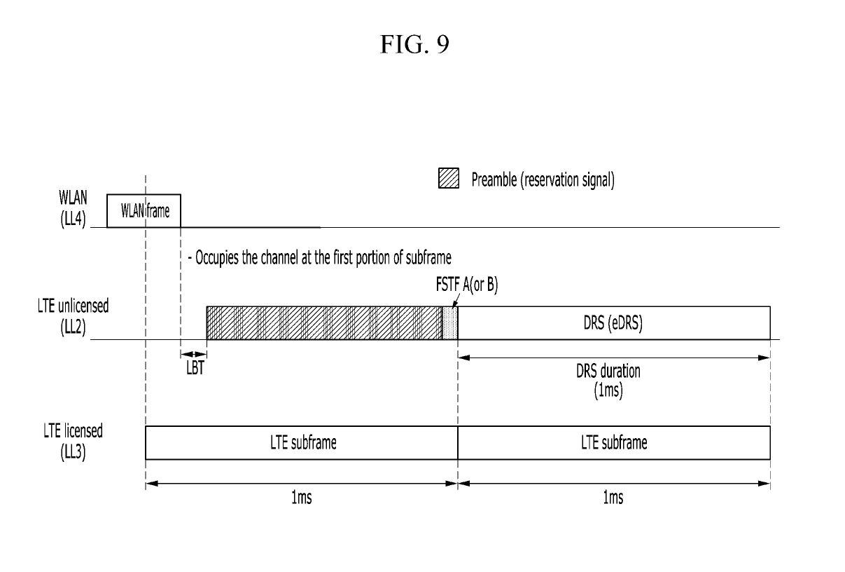

FIG. 7 shows a configuration of a preamble with a variable length applied to a DRS or an eDRS of an unlicensed band according to an exemplary embodiment of the present invention. FIG. 8 shows a short preamble according to another exemplary embodiment of the present invention. FIG. 9 shows a long preamble according to the other exemplary embodiment of the present invention.

The preamble (reservation signal) for a channel reservation has a variable length and may have the length of 1 ms as a maximum.

In detail, the preamble (reservation signal) for a channel reservation may have a variable length, and as exemplified in FIG. 8 and FIG. 9, it may not have a length (e.g., 1 ms) of the subframe but may have a same length as or a shorter length than the subframe duration. In FIG. 8 and FIG. 9, a WLAN device (LL4) for transmitting a WLAN frame signal may be the Wi-Fi device (LL1). FIG. 8 exemplifies a case in which the LTE base station (LL2) transmits a relatively short preamble (reservation signal), and FIG. 9 exemplifies a case in which the LTE base station (LL2) transmits a relatively long preamble (reservation signal).

By using the preamble (reservation signal), the LTE device (e.g., LL2) of the unlicensed band may occupy the channel of the unlicensed band and may use the same for a predetermined duration while coexisting with another type (e.g., WLAN) device (e.g., LL1 and LL4) and not providing or receiving interference. The preamble (reservation signal) may be transmitted to a start point (or an ending point) of time of the subframe section of the LTE licensed band. Therefore, the time synchronization between a signal transmission section of the licensed band and a signal transmission section of the unlicensed band may be realized. When the temporal synchronization between the subframe of the unlicensed band and the subframe of the licensed band is performed, merits are generated in performance, realization, and scheduling of a carrier aggregation (CA) function. Therefore, the present standardization presupposes that the above-noted synchronization must be performed.

In detail, FIG. 7 exemplifies a configuration of a preamble applied to the DRS (or eDRS) burst (e.g., Bdrs1 and Bdrs2). A preamble signal s(n) may be provided before a boundary of the subframe, and may be generated in advance with reference to sampling of 30.72 MHz (Msps).

A region of the preamble (reservation signal) with the characteristic of a variable length may include, as exemplified in FIG. 7, a minimum signal unit transmission section with a length of about 0.521 μs. When a digital sample rate of the LTE is 30.72 MHz, a time (Tₛ) for transmitting a same is 1/(30.72e6)=0.326 μs. Therefore, a transmission time of a sequence with a length of 16 according to an exemplary embodiment of the present invention is 16/(30.72e6)=0.521 μs. For reference, the transmission time of the LTE OFDM symbol is 2048/(30.72e6)=66.67 μs. The transmission time (or length) of a cyclic prefix is 144/(30.72e6)=4.69 is or 160/(30.72e6)=5.2083 μs. A length (or transmission time) of one LTE subframe is 30720/(30.72e6)=1 ms. That is, when the 1920 sequences, that is, a basic unit of the preamble (reservation signal), are consecutively transmitted, it becomes 1 ms (i.e., one LTE subframe may be divided into 1920 sections).

A sequence s(n) with a length of 16 in a time domain may be generated by Equation 1.

$$s ( n ) = p \cdot {\sum }_{k = - 8}^{7} exp ( j \cdot 2 π \cdot Δ f \cdot k \cdot n ) \cdot z ( k ) \qquad ( Equation 1 )$$

Here, p is a constant for normalizing a signal, and it is given that

Δf=(30.72 MHz)/16.

A sequence z(k) and an index k in a frequency domain may be defined as expressed in Equation 2.

z(k)=[0 0 0 a₋₅ a₋₄ a₋₃ a₋₂ a₋₁ 0 a₁ a₂ a₃ a₄ a₅ 0 0]

k={−8 −7 −6 −5 −4 −3 −2 −1 0 1 2 4 5 6 7} (Equation 2)

In Equation 2, a_{—5} to a₅ are complex numbers and may be defined as expressed in Equation 3 by binary bits.

bₖ=0, aₖ=1+j

bₖ=1, aₖ−1−j (Equation 3)

The binary bits b₋₅ to b₅ may be determined by N_{ID}⁽²⁾ and N_{ID}⁽¹⁾ which are physical cell IDs of the base station defined in the LTE standard and may be mapped on Equation 4.

B(N_{ID}⁽²⁾)=b₄b₅

B(N_{ID}⁽¹⁾)=b₋₅b₋₄b₋₃b₋₂b₋₁b₁b₂b₃ (Equation 4)

Here, B(.) is a binary operator function for conversion into binary numbers. For example, assuming that N_{ID}⁽²⁾=2 and N_{ID}⁽¹⁾=97, the binary number b₋₅b₋₄b₋₃b₋₂b₋₁b₁b₂b₃b₄b₅ is determined to be 0110000110. Hence, z(k) becomes [0 0 0 1+j −1 −j −1 −j 1+j 1+j 0 1+j 1+j −1−j −1−j 1+j 0 0].

When p is 4 and z(k) is converted into the time domain based on Equation 1, the sequence s(n) may be generated.

s(n)=[0.125+j0.125−0.1082−j0.1082 0.2134+j0.2134−0.1904−j0.1904−0.25−j0.25 0.3672+j0.3672 0.0336+0.0366−0.0686−j0.0686−0.125−j0.125−0.0686−j0.0686 0.0366+0.0366 03672+j0.3672−0.25−j0.25−0.1904−j0.1904 0.2134+0.2137−0.1082−j0.1082]

The variable-length preamble (reservation signal) according to an exemplary embodiment of the present invention has granularity of about 0.5 μs, so it is possible for the device (e.g., LL2) operable in the unlicensed band to have a high degree of freedom, occupy a coexistence channel in any case, and be time-synchronized (i.e., subframe time) with the licensed band.

FIG. 8 exemplifies a case in which the LTE base station (LL2) occupies a channel of the unlicensed band near a final portion (an ending portion) of the LTE subframe of the licensed band. In this case, the LTE base station (LL2) may transmit a short preamble (reservation signal).

FIG. 9 exemplifies a case in which the LTE base station (LL2) occupies a channel of the unlicensed band near a first portion (a starting portion) of the LTE subframe of the licensed band when passing through the boundary of the LTE subframe of the licensed band. In this case, the LTE base station (LL2) may transmit a long preamble (reservation signal).

The transmission of the preamble signal s(n) may be canceled so as to increase the probability for transmitting the DRS or eDRS according to a result of the LBT. In a like manner, the transmission of the FSTF signal may be canceled.

An FSTF signal (e.g., FSTF type-A signal or FSTF type-B signal) for fine OFDM symbol timing will now be described in detail.

An FSTF region configured to acquire the time synchronization may be configured with one OFDM symbol. The FSTF signal sequence may be provided between a next position to the preamble (reserved) signal s(n) and a data region (e.g., DRS zone or eDRS zone). A length of the FSTF signal sequence may be fixed to be 2192 or 2208 with reference to the sampling of 30.72 MHz.

The basic FSTF sequence s₁₀₂₄(n) may be configured with a time sample of a length of 2048, and may occupy the transmission time of 66.67 μs. A method for configuring s₁₀₂₄(n) begins with a generation of a Golay sequence with a length of 1024. A method for generating the Golay sequence may use Equation 5.

A₀(n)=δ(n)

B₀(n)=δ(n)

Aₖ(n)=WₖAₖ₋₁(n)+Bₖ₋₁(n−Dₖ)

Bₖ(n)=WₖAₖ₋₁(n)−Bₖ₋₁(n−Dₖ) (Equation 5)

In Equation 5, δ(n) signifies a Dirac delta function (which has an output value of 1 when an index n is 0, and which has an output value of 0 in other cases).

In Equation 5, it is defined that Dₖ=[1 8 2 32 4 16 64 128 256 512] (k=1, 2, . . . 10).

Further, Aₖ(n) and Bₖ(n) have a value of 0 in the section of n<0 and 2^{k}≦n.

yₖ represents concatenated bipolar bits configured with physical cell IDs (e.g., N_{ID}⁽²⁾ and N_{ID}⁽¹⁾).

As expressed in Equation 6 given below, the bipolar bits y₁ to y₂ may be found based on N_{ID}⁽²⁾, and eight other bits may be found based on N_{ID}⁽¹⁾.

B(N_{ID}⁽²⁾)=y₁y₂

B(N_{ID}⁽¹⁾)=y₃y₄y₅y₆y₇y₈y₉y₁₀ (Equation 6)

In Equation 6, B(.) represents a bipolar sign operator. The binary bits are expressed as a vector and may be expressed as in Equation 7.

y^{PCI}=[y₁y₂y₃y₄y₅y₆y₇y₈y₉y₁₀]

For example, assuming that N_{ID}⁽²⁾=2 and N_{ID}⁽¹⁾=97, the concatenated binary sequence yₖ^{PCI} becomes 0110000110. yₖ^{PCI} represents a k-th element from among elements of the sequence found based on the physical cell ID of the base station.

Here, a binary addition (or scrambling) of ten least significant bits (LSBs) or most significant bits (MSBs) from among 28 bits of a public land mobile network (PLMN) identification (ID) of the base station, and yₖ^{PCI} may be defined in Equation 8.

Wₖ=(yₖ^{PCI}+cₖ^{PLMN}^{_}^{ID})mod 2, k=1,2, . . . ,10 (Equation 8)

In Equation 8, cₖ^{PLMN}^{_}^{ID} represents a k-th binary bit of the PLMN ID (cₖ^{PLMN}^{_}^{ID} is a k-th element of the elements of the sequence found based on the PLMN ID of the base station). In Equation 8, Wₖ represents a k-th element of the elements of the sequence found after a binary addition based on the scrambling of the physical cell ID of the base station and the PLMN ID. Therefore, when the LSB of cₖ^{PLMN}^{_}^{ID} is configured with cₖ^{PLMN}^{_}^{ID}=[0 1 0 1 0 1 1 1 1 0] and yₖ^{PLMN}^{_}^{ID} is configured with yₖ^{PCI}=[0 1 1 0 0 0 0 1 1 0], Wₖ becomes Wₖ=[1 1 −1 −1 1 −1 −1 1 1 1].

A Golay initial sequence may be generated by using Equation 5 and Equation 8. Here, the Golay initial sequence z₁₀₂₄(n)=A₁₀(1024−n) may be applied to the FSTF type-A signal applied to the DRS. A Golay initial sequence z₁₀₂₄(n)=B₁₀(1024−n) may be applied to the FSTF type-B signal applied to the eDRS.

To generate the FSTF signal (e.g., FSTF type-A signal or FSTF type-B signal), z₁₀₂₄(n) may be converted into the frequency domain as expressed in Equation 9.

$${S}_{1024} ( k ) = {\sum }_{n = 0}^{1023} exp ( - j \frac{2 π \cdot k \cdot n}{1024} ) \cdot {z}_{1024} ( n ) , \\ k = - 512 , - 511 , … 0 , … , 511 \qquad ( Equation 9 )$$

The sequence converted into the frequency domain may be mapped on an extended sequence or vector) as expressed in Equation 10.

S₁₀₂₄(k)=[S₁₀₂₄(0),S₁₀₂₄(1), . . . S₁₀₂₄(511),0, . . . 0, . . . 0,S₁₀₂₄(−512), . . . S₁₀₂₄(−1)], k=−1024,−1023, . . . 0, . . . 1023 (Equation 10)

Here, an extension of the bandwidth of the transmission signal may be used. The extension of the bandwidth (or transmission width) may be defined as expressed in Equation 11.

S₁₀₂₄(k)=[S₁₀₂₄(0), . . . S₁₀₂₄(511),S₁₀₂₄(−512), . . . ,S₁₀₂₄(−481),0, . . . 0, . . . 0,S₁₀₂₄(480), . . . ,S₁₀₂₄(511),S₁₀₂₄(−512), . . . S₁₀₂₄(−1)],

k=−1024,−1023, . . . 0, . . . 1022,1023 (Equation 11)

That is, thirty-two subcarriers are added to respective band edges, thereby adding a total of sixty-four subcarriers.

When S″(k) is converted into the time domain, the sequence s₁₀₂₄(n) as defined in Equation 12 may be generated.

$${S}_{1024} ( n ) = p \cdot {\sum }_{k = - 1056}^{1055} exp ( j \cdot 2 π \cdot Δ f \cdot k \cdot ( n - {N}_{CP} {T}_{s} ) ) \cdot {S}_{1024}^{n} ( k ) , \\ n = 0 , {T}_{s} , 2 {T}_{s} , … ( 2048 + {N}_{CP} ) \cdot {T}_{s} \qquad ( Equation 12 )$$

In Equation 12, N_{CP} represents a length of the cyclic prefix. In Equation 12, p is a scaling factor for normalizing power of the transmission signal. In Equation 12, Tₛ indicates a time for transmitting a sample.

Resultantly, the base station may notify of whether a transmission of DRS is successful in the unlicensed band, by transmitting the FSTF signal (e.g., FSTF type-A signal or FSTF type-B signal). The FSTF type-A signal is transmitted between the reservation signal and the DRS, so the terminal may periodically detect the FSTF type-A signal in the DMTC period section. When the FSTF type-A signal is not detected in the DMTC period section, the terminal may detect the FSTF type-B signal in the non-DMTC period section for each predetermined period (e.g., an interval of 5 ms). When the FSTF signal (e.g., FSTF type-A signal or FSTF type-B signal) is detected, the terminal may recognize that the DRS will be transmitted soon.

The FSTF signal (e.g., FSTF type-A signal or FSTF type-B signal) is generated as binary information having scrambled the physical cell ID and the PLMN ID, so the possibility for the FSTF signal (e.g., FSTF type-A signal or FSTF type-B signal) to collide with the DRS of the adjacent small base station is low, and the probability for the same to be uniquely identified is high.

However, depending on the situation, the FSTF signal (e.g., FSTF type-A signal or FSTF type-B signal) may be replaced with the preamble s(n) with a length of 2192 or 2208, or the transmission of FSTF signal (e.g., FSTF type-A signal or FSTF type-B signal) may be canceled.

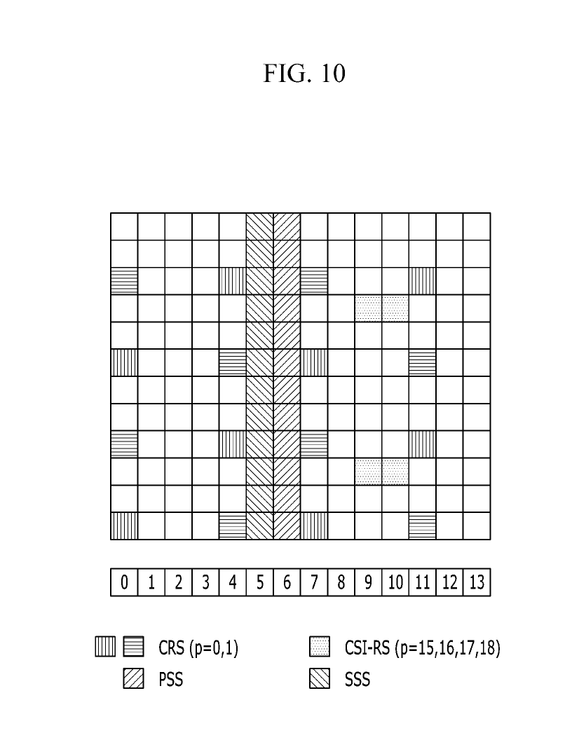

A DRS waveform in a continuous burst form will be described in detail with reference to FIG. 10 to FIG. 14.

FIG. 10 shows a default DRS according to an exemplary embodiment of the present invention. In FIG. 10, p represents an antenna port number.

The DRS is periodically transmitted in the unlicensed band, and the DRS may have a non-continuous characteristic. That is, when there are no data to be transmitted, as exemplified in FIG. 10, the DRS may have a form for not transmitting a signal to specific OFDM symbols (e.g., OFDM symbols of numbers 1 to 3, 5, 6, 8 to 10, 12, and 13).

In detail, FIG. 10 exemplifies a case in which the DRS includes synchronization signals (PSS and SSS) and the DRS is 1 ms long.

As exemplified in FIG. 10, when the DRS includes the synchronization signals (PSS and SSS), no signal is transmitted at the times corresponding to timings of the OFDM symbols of numbers 1 to 3, 8, 12, and 13. The time for transmitting one OFDM symbol is about 71 μs, and when the time is maintained at about 71 μs (or greater) while the channel idles, the device (e.g., LL1) such as a Wi-Fi device may recognize that the corresponding channel idles and may attempt to transmit a signal. In this condition, a signal collision may occur between other devices or between the LAA network and the unlicensed band, which may cause a bad influence to the entire network performance.

Therefore, to prevent the above-noted collision, a method for artificially controlling a section that makes the channel idle to be busy from among the sections configuring the DRS may be considered. Three methods (a method M110, a method M120, and a method M130) according to an exemplary embodiment of the present invention configure an alternative transmission signal for the void section (a section in which no signal is transmitted, for example, sections of the OFDM symbols of numbers 1 to 3, 5, 6, 8 to 10, 12, and 13) of the DRS. However, the sections of the OFDM symbols of numbers 12 and 13 may be left as void sections.

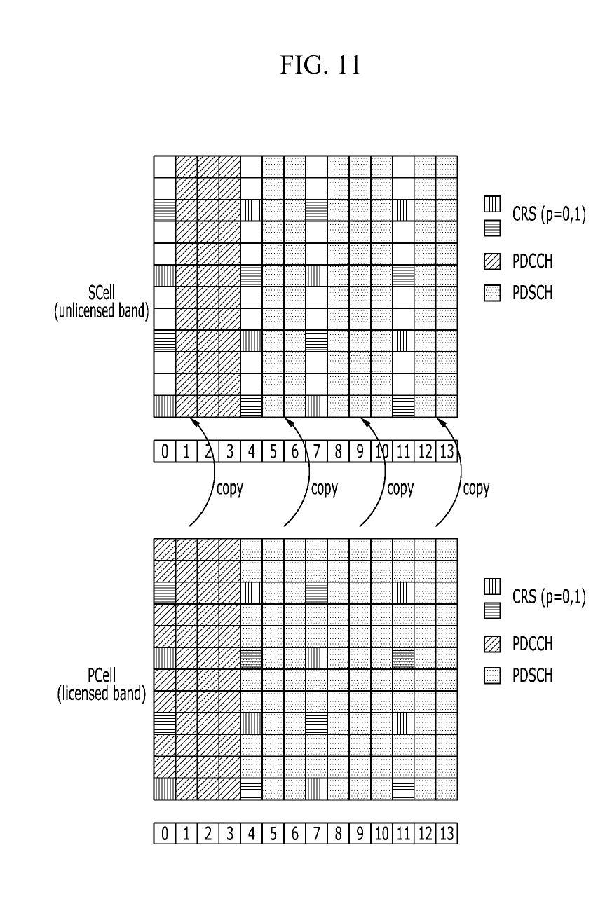

FIG. 11 shows a method for filling a physical downlink control channel (PDCCH) and a PDSCH signal of a licensed band into part of a DRS according to an exemplary embodiment of the present invention. In FIG. 11, p represents an antenna port number.

As exemplified in FIG. 11, the method M110 for filling a void section with an arbitrary signal represents a method for duplicating a PDSCH signal corresponding to the void section from among the PDSCH signals transmitted in the licensed band to the void section for respective OFDM symbols.

In detail, FIG. 11 exemplifies a case in which a primary cell (PCell) operable in the licensed band transmits a PDCCH in the section of the OFDM symbols of numbers 0 to 3, transmits a PDSCH in the section of the OFDM symbols of numbers 4 to 13, and transmits a CRS in the section of the OFDM symbols of numbers 0, 4, 7, and 11.

In the void section (e.g., the section of the OFDM symbols of numbers 1 to 3) of the DRS, a secondary cell (SCell) operable in the unlicensed band may transmit the PDCCH and the PDSCH transmitted by the PCell in the corresponding OFDM symbol section. Further, in another void section (e.g., the section of the OFDM symbols of numbers 5, 6, 8 to 10, 12, and 13) of the DRS, the SCell may transmit the PDSCH, the SSS, the PSS, the CSI-RS, and a demodulation-reference signal (DM-RS) transmitted by the PCell in the corresponding OFDM symbol section.

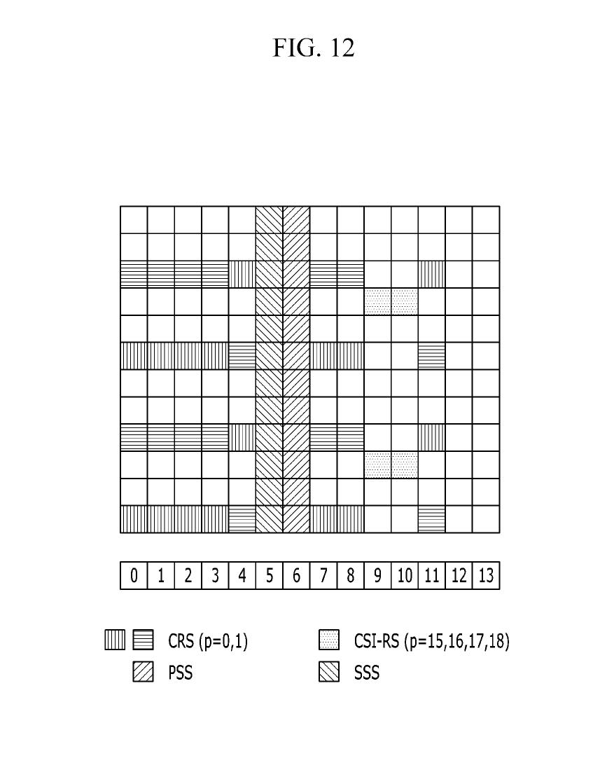

FIG. 12 shows a method for filling an existing reference signal into a void section of a DRS according to an exemplary embodiment of the present invention. In FIG. 12, p indicates an antenna port number.

As exemplified in FIG. 12, the method M120 represents a method for extending or adding a reference signal (e.g., CRS) and filling the same in various void OFDM sections.

The method M120 extends the CRS (antenna ports of numbers 0 and 1) mapped on the OFDM symbols of numbers 0, 4, and 7, and fills the same in the void section (e.g., the section of the OFDM symbols of numbers 1 to 3 and 8 to 10) of the DRS exemplified in FIG. 10. Further, the method M120 may fill the CSI-RS and the synchronization signals (PSS and SSS) in the region (e.g., the section of the OFDM symbols of numbers 5, 6, 9, and 10) that may not be filled.

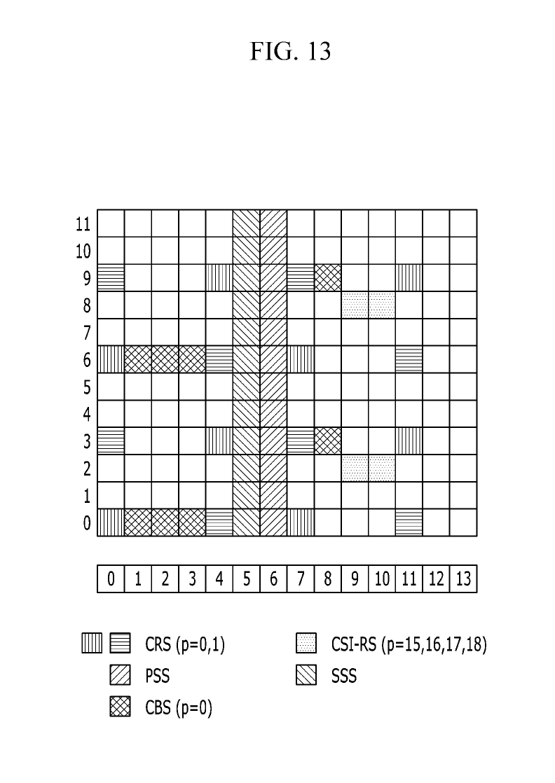

FIG. 13 shows a method for filling a cell-specific broadcast signal (CBS) into a void section of a DRS according to an exemplary embodiment of the present invention. In FIG. 13, p represents an antenna port number.

The method M130 represents a method for inserting a CBS signal into the void section of the DRS. Here, the CBS represents a signal having the same resource element mapping as the existing CRS and having a different symbol configuration from the CRS.

In detail, a CBS region (the region on which the CBS is mapped) may have a configuration of the CRS (using one antenna port (e.g., an antenna port of number 0)) mapped on the existing LTE OFDM symbol of number 0 or 7, which may be defined by Equation 13. For example, FIG. 13 exemplifies a case in which the CBS is mapped on the resource elements corresponding to the subcarriers of numbers 0 and 6 from among the resource elements corresponding to the OFDM symbols of numbers 1 to 3, and the CBS is mapped on the resource elements corresponding to the subcarriers of numbers 3 and 9 from among the resource elements corresponding to the OFDM symbol of number 8.

a_{k,l}^{(p)}=rₗ(m′) (Equation 13)

In Equation 13, a is a complex symbol representing a signal input to an inverse fast Fourier transformation (IFFT) block. In Equation 13, p indicates an antenna port and corresponds to an index k on the frequency axis and an index I of the OFDM symbol.

In Equation 13, k, I, and m may be defined as expressed in Equation 14.

k=6m+(v+v_{shift})mod 6

l=1, 2, 3 or 8

m=0,1,2, . . . ,2·N·N_{RB}^{DL}−1

m′=m+N_{RB}^{max,DL}−N_{RB}^{DL}

In Equation 14, N_{RB}^{DL} signifies a number of PRBs corresponding to an entire system downlink bandwidth, and N_{RB}^{max,DL} represents the greatest PRB number corresponding to the entire system downlink bandwidth.

v may be defined as

$$v = \{ \begin{matrix}0 & if p = 0 and l = 0 \\ 3 & if p = 1 and l \neq 0\end{matrix} ,$$

and v_{shift} may be defined as v_{shift}=N_{ID}^{cell} mod 6. N_{ID}^{cell} represents a physical cell ID.

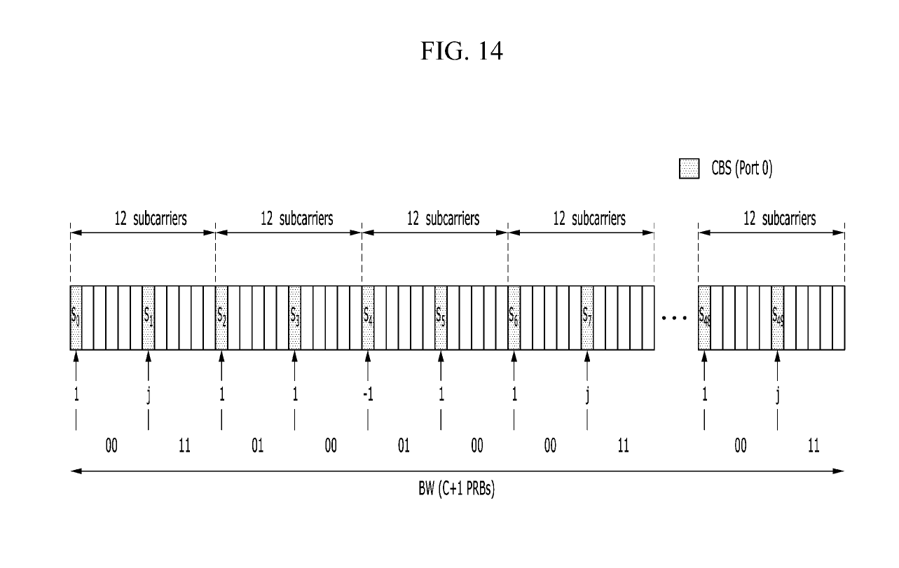

FIG. 14 shows a method for mapping a CBS on a frequency axis and a modulation method for respective symbols according to an exemplary embodiment of the present invention.

S₀, S₁, . . . , S₄₈ exemplified in FIG. 14 represent modulation symbols configuring the CBS.

Assuming that N_{RB}^{DL} is 25 (5 MHz bandwidth), a total of forty-nine CBS symbols (S₀-S₄₈, here, the first modulation symbol S₀ is a dummy) may be mapped on the band N_{RB}^{DL}, and all CBS symbols may be mapped on the 98 bits.

In Equation 13, r₁(m′) is configured with differential quadrature phase shift keying (D-QPSK) symbols, and it may be defined as expressed in Equation 15.

$${r}_{l} ( i ) = {z}_{i} \cdot {z}_{i + 1} \\ {z}_{0} = {s}_{init} \\ {z}_{i} = \{ \begin{matrix}{\tilde{c}}_{i} = 0 , {\tilde{c}}_{i + 1} = 0 , & {z}_{i} = exp ( j \cdot \frac{π}{2} ) \\ {\tilde{c}}_{i} = 0 , {\tilde{c}}_{i + 1} = 1 , & {z}_{i} = exp ( j \cdot π ) \\ {\tilde{c}}_{i} = 1 , {\tilde{c}}_{i + 1} = 0 , & {z}_{i} = exp ( j \cdot \frac{3 π}{2} ) \\ {\tilde{c}}_{i} = 1 , {\tilde{c}}_{i + 1} = 1 , & {z}_{i} = exp ( 2 jπ )\end{matrix} , \\ i = 1 , … , C \qquad ( Equation 15 )$$

In Equation 15, sᵢₙᵢₜ is a QPSK symbol (x=l+jQ), and an in-phase and a quadrature-phase are 1/\sqrt{2}. In Equation 15, \tilde{c} is a channel-coding applied coded bit. In Equation 15, C represents a length of an entire codeword, and when N_{RB}^{DL} is 25, C is 49. FIG. 14 exemplifies a case in which a bandwidth includes (C+1)-numbered PRBs.

When the void section of the DRS is filled according to at least one of the above-described method M110, method M120, and method M130, the DRS (or eDRS) burst may be transmitted.

A method for controlling a length of the DRS will now be described.

In detail, the device (e.g., LL2) transmits the DRS when determining that the channel idles through the LBT in the unlicensed band, and in this instance, it may control the length of the DRS.

The method for controlling the length of the DRS may be applied when the DRS does not include downlink PDSCH data. The length of the DRS may be determined by the number of OFDM symbols. Hence, the available transmission number N_{DRS} of OFDM symbols of the DRS may be determined by Equation 16.

$${N}_{DRS} = ⌈ \frac{{T}_{DRS}}{2192 \cdot {T}_{s}} ⌉ \qquad ( Equation 16 )$$

In Equation 16, T_{DRS} represents a time unit predetermined by a radio resource control (RRC), and has the unit of seconds. In Equation 16, Tₛ is 1/30.72e6=0.000000032552 s.

In summary, the length of the DRS occasion is not fixed as a single value, so the DRS occasion may be set to be shorter than one subframe (e.g., it may be shorter than the length of fourteen OFDM symbols), systematically. In another way, the DRS occasion may be set to be relatively long (e.g., 1 to 5 ms), systematically.

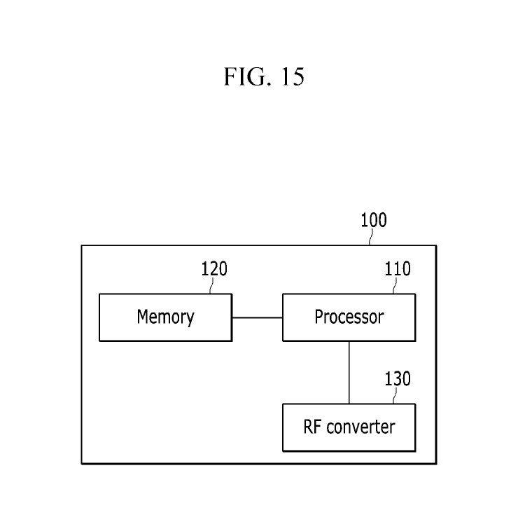

FIG. 15 shows a base station according to an exemplary embodiment of the present invention.

The base station 100 includes a processor 110, a memory 120, and a radio frequency (RF) converter 130.

The processor 110 may be composed to realize functions, processes, and methods that are described in relation to the base station (e.g., LL2). Further, the processor 110 may control respective configurations of the base station 100.

The memory 120 is connected to the processor 110, and stores various kinds of information relating to an operation of the processor 110.

The RF converter 130 is connected to the processor 110, and transmits or receives radio signals. The base station 100 may have a single antenna or multiple antennas.

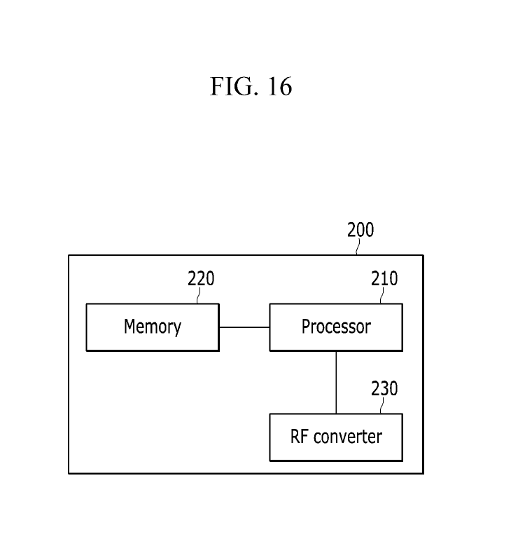

FIG. 16 shows a terminal according to an exemplary embodiment of the present invention.

The terminal 200 includes a processor 210, a memory 220, and an RF converter 230.

The processor 210 may be composed to realize functions, processes, and methods that are described in relation to the terminal in the present specification. Further, the processor 210 may control respective configurations of the terminal 200.

The memory 220 is connected to the processor 210, and stores various kinds of information relating to an operation of the processor 210.

The RF converter 230 is connected to the processor 210 and transmits or receives radio signals. The terminal 200 may have a single antenna or multiple antennas.

According to the exemplary embodiments of the present invention, when the LBT function is applied to the unlicensed band and the DRS fails in transmission, the base station and the terminal may autonomously and efficiently control the failure.

A probability that the DRS may not be transmitted for each predetermined timing exists according to the characteristic of the unlicensed band, and it is difficult for the PSS and the SSS, existing narrowband synchronization signals, to provide a precise OFDM symbol timing by receiving the DRS once. Accordingly, when a transmission failure occurs, it requires further time for the terminal to acquire the time synchronization by that much. However, according to an exemplary embodiment of the present invention, the terminal may acquires the accurate OFDM symbol timing through the synchronization signal (e.g., a fine symbol time field (FSTF) type-A signal, or an FSTF type-B signal) by receiving the DRS once, which may reduce the synchronization acquisition time of the terminal.

Further, according to an exemplary embodiment of the present invention, a preamble for occupying and reserving the channel and an OFDM symbol synchronization signal FSTF are added to a DRS burst before a transmission of a DRS (or an extended DRS), so the existing LTE physical layer standard may not be changed much, synchronization between the licensed band and the unlicensed band may be maintained, and the method according to an exemplary embodiment of the present invention may be applied to the unlicensed band so as to operate the LTE system.

Also, according to an exemplary embodiment of the present invention, excellent element techniques applicable to the LTE-LAA (license assisted access) of the LTE operating standardization technology for the unlicensed band may be provided.

Further, according to an exemplary embodiment of the present invention, the existing DRS configuration is used as it is, so it is possible to multiplex the DRS and transmit the same like the case of transmitting data such as a physical downlink shared channel (PDSCH).

In addition, according to an exemplary embodiment of the present invention, a length of the DRS occasion is not fixed, so a case in which the DRS occasion is shorter than one subframe (e.g., a unit that is less than a fourteen OFDM symbol length) may be set in the system, and it is possible to systematically set the DRS occasion to be relatively long (e.g., 1 to 5 ms).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a base station to transmit a discovery reference signal (DRS) through a channel of an unlicensed band, the method comprising:
attempting a first access to the channel of the unlicensed band so as to transmit a first DRS in a first DRS measurement timing configuration (DMTC) period; and
when the first access fails, attempting a second access to the channel of the unlicensed band with a predetermined period that is shorter than the first DMTC period so as to transmit a second DRS in the first DMTC period.

2. The method of claim 1, wherein
the predetermined period represents a period for transmitting a synchronization signal in a licensed band, and
the attempting of a second access includes
attempting the second access with the predetermined period until a transmission of the second DRS is successful in the first DMTC period.

3. The method of claim 2, wherein
the synchronization signal includes at least one of a primary synchronization signal (PSS) and a secondary synchronization signal (SSS), and
the predetermined period is 5 ms.

4. The method of claim 2, further comprising
when the second access is successful, multiplexing the second DRS and a physical downlink shared channel (PDSCH) and transmitting the same.

5. The method of claim 2, further comprising
when the second access is successful, transmitting a synchronization signal included in the second DRS from a same resource element as a resource element for transmitting the synchronization signal in the licensed band.

6. The method of claim 1, wherein
the attempting of a second access includes:
sensing the unlicensed band channel; and
when the channel of the unlicensed band is sensed to idle, transmitting a reservation signal with a variable length so as to reserve the channel of the unlicensed band.

7. The method of claim 6, wherein
the transmitting of a reservation signal includes
generating a time domain sequence for the reservation signal by using Equation 1:
$$s ( n ) = p \cdot {\sum }_{k = - \frac{N}{2}}^{\frac{N}{2} - 1} exp ( j \cdot 2 π \cdot Δ f \cdot k \cdot n ) \cdot z ( k ) \qquad ( Equation 1 )$$
wherein s(n) is the time domain sequence including N-numbered elements, p is a normalization constant,
$$Δ f = \frac{{f}_{s}}{N} ,$$
fₛ is a sampling rate, and z(k) is a frequency domain sequence including an element having a value that is based on a physical cell ID of the base station.

8. The method of claim 6, further comprising
when the second access is successful, transmitting a first fine symbol time field (FSTF) signal for notifying a terminal of a transmission of the second DRS from a time when a transmission of the reservation signal is finished to a time for transmitting the second DRS.

9. The method of claim 8, wherein
the transmitting of a first FSTF signal includes:
finding a first sequence using Equation 1; and
generating a Golay sequence for the first FSTF signal based on the first sequence:
Wₖ=(bₖ^{PCI}+cₖ^{PLMNID})mod 2 [Equation 1]
wherein Wₖ is a k-th element from among elements of the first sequence, bₖ^{PCI} is a k-th element of elements of a sequence found based on a physical cell ID of the base station, and cₖ^{PLMNID} is a k-th element of elements of a sequence found based on a public land mobile network (PLMN) ID of the base station.

10. The method of claim 9, wherein
the generating of a Golay sequence includes
generating the Golay sequence by using Equation 2:
A₀(n)=δ(n)
B_{b}(n)=δ(n)
Aₖ(n)=WₖAₖ₋₁(n)+Bₖ₋₁(n−Dₖ)
Bₖ(n)=WₖAₖ₋₁(n)−Bₖ₋₁(n−Dₖ)
Dₖ=[1 8 2 32 4 16 64 128 256 512](k=1,2, . . . 10)
z₁₀₂₄(n)=B₁₀(1024−n)
wherein δ(n) is a Dirac delta function having a value of 1 when n=0 and having a value of 0 in other cases, and z₁₀₂₄(n) is the Golay sequence.

11. The method of claim 1, wherein
the second DRS includes a primary synchronization signal (PSS), a secondary synchronization signal (SSS), and a cell-specific reference signal (CRS), and
times for starting and ending a transmission of the second DRS correspond to a boundary of a subframe for a licensed band.

12. The method of claim 1, wherein
the predetermined period corresponds to a length of a subframe for a licensed band.

13. The method of claim 12, wherein
the attempting of a second access includes
attempting the second access with the predetermined period until a transmission of the second DRS is successful in a DMTC window configured in the first DMTC period.

14. A method for a base station to transmit a discovery reference signal (DRS) through a channel of an unlicensed band, the method comprising:
generating a first DRS with a predetermined time length; and
mapping a first signal on a remaining time domain symbol except a time domain symbol on which a signal is mapped from among time domain symbols belonging to the first DRS.

15. The method of claim 14, wherein
the first signal includes at least one of a physical downlink control channel (PDCCH) and a physical downlink shared channel (PDSCH), and
the mapping of a first signal includes
mapping the first signal transmitted through a channel of a licensed band in a same time domain symbol as the remaining time domain symbol of the first DRS on the remaining time domain symbol of the first DRS.

16. The method of claim 14, wherein
the generating of a first DRS includes
generating a cell-specific reference signal (CRS), and
the mapping of a first signal includes
mapping the CRS included in the first DRS on at least one of remaining time domain symbols of the first DRS by using the CRS included in the first DRS as the first signal.

17. The method of claim 14, wherein
the mapping of a first signal includes
generating a cell-specific broadcast signal (CBS) using an antenna port, as the first signal.

18. The method of claim 17, wherein
the mapping of a first signal further includes
determining a region on which the CBS is mapped based on k and m′ found by Equation 1:
k=6m+(v+v_{shift})mod 6
m=0,1,2, . . . ,2·N_{RB}^{DL}−1
m′=m+N_{RB}^{max,DL}−N_{RB}^{DL}−1
v_{shift}=N_{ID}^{cell}mod 6
wherein N_{RB}^{DL} is a number of physical resource blocks (PRBs) corresponding to an entire downlink bandwidth, N_{RB}^{max,DL} is a maximum PRB number corresponding to the entire downlink bandwidth, N_{ID}^{cell} is a physical cell ID of the base station, and v is one of 0 and 3.

19. A method for a terminal to receive a discovery reference signal (DRS) through a channel of an unlicensed band, the method comprising:
determining whether a first fine symbol time field (FSTF) signal for a first DRS is detected in a DRS measurement timing configuration (DMTC) period; and
when the detection of the first FSTF signal fails, attempting to detect a second FSTF signal for a second DRS with a predetermined period.

20. The method of claim 19, further comprising
when the detection of the second FSTF signal is successful, receiving the second DRS together with a physical downlink shared channel (PDSCH),
wherein the predetermined period represents a period for transmitting a synchronization signal in a licensed band.
